(19) United States
(12) Patent Application Publication
(10) Pub. No.: US 2015/0018066 A1
(43) Pub. Date: Jan. 15, 2015

(54) Online lottery system and method for providing a winning insurance

(71) Applicant: REDDUCK INC., Seoul (KR)

(72) Inventor: Seung Taek OH, Seoul (KR)

(73) Assignee: REDDUCK INC., Seoul (KR)

(21) Appl. No.: 14/300,175

(22) Filed: Jun. 9, 2014

(30) Foreign Application Priority Data
Jun. 10, 2013 (KR) 10-2013-0065949

(51) Int. Cl. G07F 17/32

(52) U.S. Cl. CPC G07F 17/3262; G07F 17/329
USPC 463/17

(57) ABSTRACT

The present invention relates to an online drawing system for providing winning insurance which provides a user with item contents that the user wants, regardless of whether the item contents are won, when the item contents are not won within a predetermined number of drawing times by setting up insurance for drawings in an online drawing system that provides item contents by drawing. According to the present invention, it is possible to enable a user to keep participating in a drawing at ease even if the user is not won even at a large number of drawing times, by providing winning insurance which provides the user with desired item contents, even if the user enters the drawing and the item contents are not won till a predetermined number of drawing times, and the conditions for acquiring item contents are gradually achieved with an increase in number of drawing times.

### CROSS-REFERENCE TO RELATED APPLICATION

This application claims the benefit of Korean Application No. 10-2013-0065949, filed on Jun. 10, 2013, with the Korean Intellectual Property Office, the disclosure of which is incorporated herein by reference.

### BACKGROUND OF THE INVENTION

1. Field of the Invention

The present invention relates to an online drawing system for providing winning insurance, and more particularly to an online drawing system for providing winning insurance which provides a user with item contents that the user wants, regardless of whether the item contents are won, when the item contents are not won within a predetermined number of drawing times by setting up insurance for draws in an online drawing system that provides item contents by drawing.

2. Description of the Related Art

Online games that are provided at present provide various item contents themselves and the item contents are applied to the online games and give the online games variety in a way of strengthening the ability of players or changing the game environments.

For example, the item contents are given various attributes for each type and specific ability values measured in the online games are preset different for each of the attributes in the same type of different item contents, so the degree of strengthening the ability of players and the level of change in game environment depend on the attributes and ability values given to the item contents.

Accordingly, the players who participate in online games try to increase the degree of strengthening their abilities by obtaining high-class item contents having various attributes and high ability values set for the attributes in order to show their own specific characteristics and hold advantageous positions more than other players in the online games. The providers who provide online game services, however, distribute a small number of high-class item contents to prevent the game balance from breaking, so the scarcity value of the high-class item contents naturally increases.

Accordingly, players have attempted to increase the probability of obtaining scarce high-class item contents by playing online game for a long period of time in order to obtain the high-class item contents.

However, beginners who have played online games only for a short period of time take too much time to obtain those high-class item contents and they even have difficulty in keeping their positions among high-level players, such that they naturally lose interest in the online games.

However, recently, it has been increasingly attempted to give chances even for beginners to obtain high-class item contents by providing high-class item contents by drawing lots.

However, there is also probability in the way of distributing item contents by drawing lots, so there is no guarantee that high-class contents are surely won. Accordingly, there is a problem in that users who are unfortunate in drawings cannot win high-class item contents in spite of the continuous cost for draws.

It may further decrease the degree of participation in online games and further increase the negative view to the drawing system.

Accordingly, it is required to introduce a new type of drawing system for solving those problems.

### PRIOR ART DOCUMENT

### Patent Document

Korean Patent Registration No. 1007195

### SUMMARY OF THE INVENTION

In order to solve the problems, an object of the present invention is to guarantee users who enter drawings over a predetermined number of times to win desired item contents by providing winning insurance that supplies the users with the item contents, when they fail to win the item contents till a predetermined number of drawing times, in a system for providing specific item contents by drawing lots.

Another object of the present invention is to prevent too much expense for draws through winning insurance and increase satisfaction and participation of users in drawings by necessarily providing the users with their desired item contents, even if they fail to win the item contents till a predetermined number of times.

According to an aspect of the present invention, an online drawing system, which provides item contents that are used in an online game in online by drawing the item contents in combination with a game contents server that provides the item contents, includes: a capsule matching unit that creates drawing event information by matching one or more of the item contents with at least one of a predetermined number of capsules, respectively, or by determining a winning probability of the item contents; a drawing event providing unit that provides the drawing event according to the created drawing event information to a client terminals by controlling the capsule matching unit; a drawing control unit that determines whether the item contents are won by a capsule drawn in the drawing event by the client terminal participating in the drawing event; and a winning insurance unit that registers the item contents in the membership information of the user of the client terminal, when the item contents are not won till a predetermined number of drawing times, in combination with the drawing control unit.

The online drawing system may further include a winning insurance providing unit that provides the client terminal with winning insurance contents for activating the winning insurance unit, and the winning insurance unit activates, when receiving the winning insurance contents from the client terminal.

The winning insurance selling unit may provide different winning insurance contents and the winning insurance unit may change the predetermined number of drawing times in accordance with the types of the winning insurance contents.

The winning insurance unit may register item contents in the membership information, when the item contents are not won till the predetermined number of drawing times, by counting the number of drawing times by the drawing control unit.

The winning insurance unit may change the predetermined number of drawing times in accordance with the number of capsules in the drawing event information in combination with the drawing control unit.

The winning insurance unit may be inactivated, when the item contents is registered in membership information or the item contents or drawn within the predetermined number of drawing times.

The drawing control unit may reset the drawing event information, when the item contents in the drawing event information are all won.

The item contents in the drawing event information may be different types of item contents.

The winning insurance unit may provide an interface for receiving one or more selected from the item contents in the drawing event information through selection information of the client terminal, and may register the item contents selected through the interface in membership information, when the item contents selected through the interface are not won till the predetermined number of drawing times.

The drawing control unit may register won item contents in the membership information of the user of the client terminal.

According to aspect of the present invention, an online drawing method, which provides item contents that are used in an online game in online by drawing the item contents in combination with a game contents server that provides the item contents, includes: a first step unit that creates drawing event information by matching one or more of the item contents with at least one of a predetermined number of capsules, respectively, or by determining a winning probability of the item contents; a second providing unit that provides the drawing event according to the created drawing event information to a client terminals through the first step; a third that determines whether the item contents are won by a capsule drawn in the drawing event by the client terminal participating in the drawing event; and a fourth step that registers the item contents in the membership information of the user of the client terminal, when the item contents are not won till a predetermined number of drawing times in the third step.

The second step may further include a step of providing the client terminal with winning insurance contents for performing the fourth step, and the fourth step may be performed, when receiving the winning insurance contents as input information of the client terminal.

The second step may provide a plurality of different winning insurance contents, and the fourth step may change the predetermined number of drawing times in accordance with the types of received winning insurance contents.

The fourth step may register item contents in the membership information, when the item contents are not won till the predetermined number of drawing times, by counting the number of drawing times from the point of time when the winning insurance contents are received.

The fourth step may change the predetermined number of drawing times in accordance with the number of capsules in the drawing event information.

The online drawing method may further include a fifth step that finishes the fourth step, when the item contents are won within the predetermined number of drawing times.

The online drawing method may further include a sixth step that resets the drawing event information, when the item contents in the drawing event information are all won.

The item contents in the drawing event information may be different types of item contents.

The fourth step may provide an interface for receiving one or more selected from the item contents in the drawing event information through selection information of the client terminal, and may register the item contents selected through the interface in membership information, when the item contents selected through the interface are not won till the predetermined number of drawing times.

The third step may register won item contents in the membership information of the user of the client terminal.

According to the present invention, it is possible to enable a user to keep participating in a drawing at ease even if the user is not won even at a large number of drawing times, by providing winning insurance which provides the user with desired item contents, even if the user enters the drawing and the item contents are not won till a predetermined number of drawing times, and the conditions for acquiring item contents are gradually achieved with an increase in number of drawing times. Accordingly, it is possible to induce a user to actively enter a drawing and prevent thoughtless expenditure of a user in a drawing.

Further, according to the present invention, it is possible to provide item contents that a user wants, using insurance, so users who enter a drawing can easily achieve their objects. Further, it is possible to induce a user to actively enter a drawing and supply various item contents, using the insurance function and the drawing function, such that it is possible to considerably increase satisfactory of users in a drawing.

### BRIEF DESCRIPTION OF THE DRAWINGS

FIG. 1 is a diagram illustrating the configuration environment of an online drawing system for providing winning insurance according to an embodiment of the present invention.

FIG. 2 is a diagram illustrating the detailed configuration of a drawing server in the drawing system for providing winning insurance according to an embodiment of the present invention.

FIG. 3 is a diagram illustrating the operation of providing a draw event in the online drawing system for providing winning insurance according to an embodiment of the present invention.

FIG. 4 is a diagram illustrating the operation of providing a draw event in an online drawing system for providing winning insurance according to another embodiment of the present invention.

FIG. 5 is a diagram illustrating the operation of providing winning insurance contents in the online drawing system for providing winning insurance according to an embodiment of the present invention.

FIG. 6 is a diagram illustrating the detailed configuration of winning insurance unit in the online drawing system for providing winning insurance according to an embodiment of the present invention.

FIG. 7 is a diagram illustrating the operation of an insurance function in the online drawing system for providing winning insurance according to an embodiment of the present invention.

FIG. 8 is a diagram illustrating the operation of an insurance function in an online drawing system for providing winning insurance according to another embodiment of the present invention.

FIGS. 9 to 10 are diagrams illustrating various examples of the way of setting for counting the number of drawing times in the online drawing system for providing winning insurance according to an embodiment of the present invention.

FIG. 11 is a flowchart illustrating an online draw method in the online drawing system for providing winning insurance according to an embodiment of the present invention.

### DETAILED DESCRIPTION OF THE PREFERRED EMBODIMENTS

Hereinafter, embodiments of online drawing system for providing winning insurance according to the present invention will be described in detail.

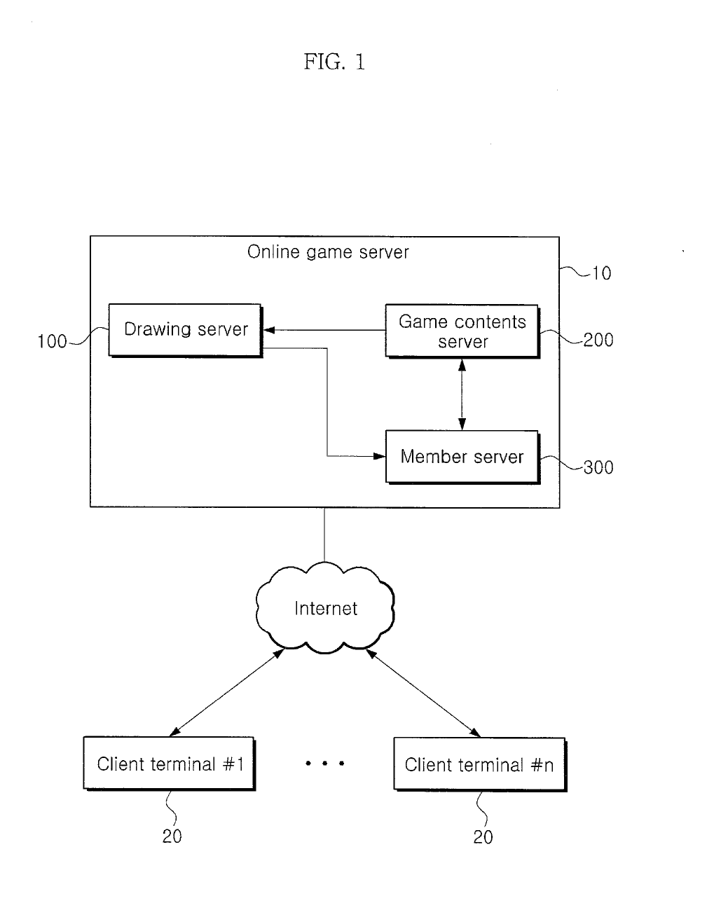

FIG. 1 is a diagram illustrating the configuration environment of an online drawing system for providing winning insurance according to an embodiment of the present invention. As illustrated in the figure, the online drawing system may include, in an online game server 10, a game contents server 200 that provides contents associated with various games, including item contents, a member server 300 that manages the information on members who are provided with the game contents in connection with the online game server 10, and a drawing server 100 that provides online drawing services to client terminals 20 of the members in combination with the game contents server 200 and the member server 300.

The process of connecting to the drawing server 100 with the client terminal 20 is described on the basis of this configuration. The client terminal 20 transmits login information to the online game server 10 through the internet and the game contents server 200 authenticates the user of the client terminal 20 on the basis of the login information, and then provides the user with various game contents, when the user is authenticated.

The game contents server 200 registers link information for connecting to the drawing server 100 on the website provided to the client terminal 20 and the client terminal 20 can connect to the drawing server 100, using the link information.

In order to register the information transmitted between the drawing server 100 and the client terminal 20 participating in an online game item drawing service and to apply the information to the game contents server 200, the member server 300 can register the information on the membership information of the user corresponding to the login information of the client terminal 20 and provide it to the game contents server 200.

The drawing server 100 provides the online drawing service to the client terminal 20, when ascertaining connection of the client terminal 20.

According to the configuration, the drawing server 100 according to an embodiment of the present invention provides a winning insurance function that supplies users participating in a drawing event with desired item contents when they fail to win the item contents till a predetermined number of drawing times. Therefore, it is possible to increase satisfaction and participation of users in drawings by providing desired item contents for the users who were not drawn even at a large number of drawing times.

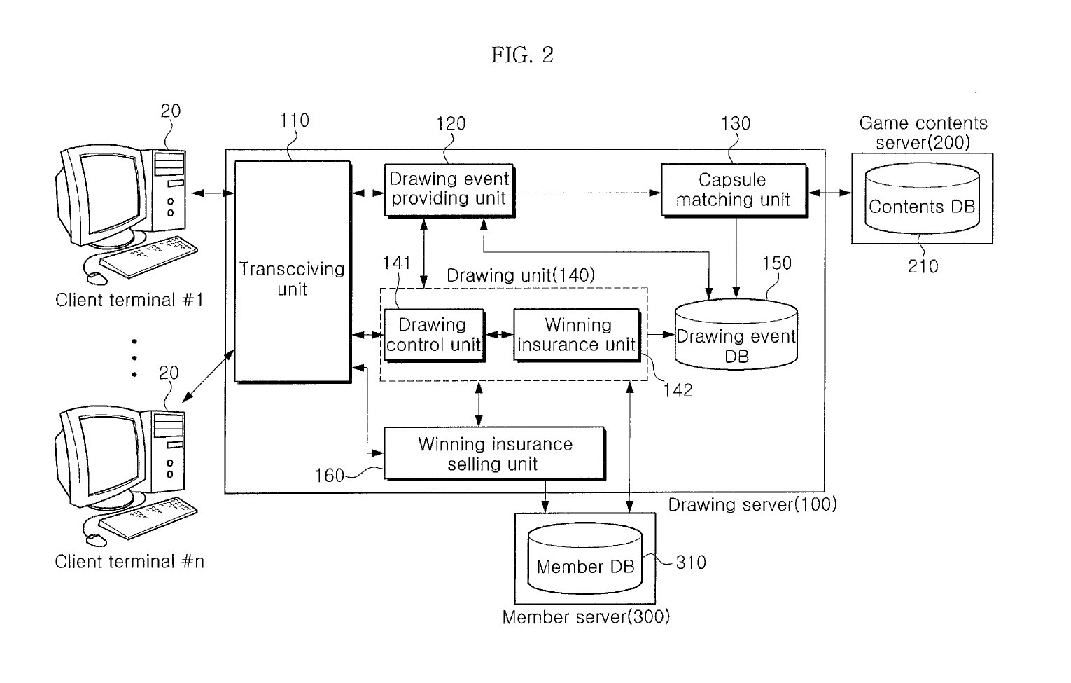

An example of the configuration of the drawing server for this purpose is described in detail with reference to FIG. 2.

As illustrated in FIG. 2, the drawing server 100 may include a transceiving unit 110, a drawing event providing unit 120, a capsule matching unit 130, a drawing unit 140, and a drawing event DB 150.

For the client terminals 20 connecting to the drawing server 100 through the transceiving unit 110, the drawing event providing unit 120 creates drawing event information by controlling the capsule matching unit 130 and provides the drawing event corresponding to the drawing event information to the client terminals 20. In this configuration, the transceiving unit 110 may be included in the drawing event providing unit 120 and the drawing unit 140, if necessary.

Under the control of the drawing event providing unit 120, the capsule matching unit 140 can create drawing event information by matching one or more item contents of a plurality of item contents in a contents DB 210 of the game contents server 200 with one or more of predetermined number of capsules in the drawing event information, and can store it in the drawing event DB 150. The capsules not matched with the item contents can be matched as ‘null’ and put into the drawing event information.

The capsules are lots for drawings, instead of the capsules, various lots (tickets, numbers, and the like.) that are available in drawings can be used, and the present invention is not limited thereto.

The capsule matching unit 130 can extract the item contents into high-class item contents having ability values, which are measured in an online game, over a predetermined value and match them with one or more capsules. Accordingly, it is possible to actively induce users to enter drawings by providing scarce high-class item contents as giveaways.

Further, the capsule matching unit 130 may create drawing event information by matching a plurality of item contents with one or more capsules in the drawing event information or matching the drawing event information with each capsule one to one, in which some of the item contents may constitute high-class item contents and the others may constitute common item contents with ability values under a predetermined value. The capsule matching unit 130 may divide high-class item contents and common item contents into different types of item contents and create drawing event information for each of them.

The drawing event providing unit 120 can provide a drawing event list for a plurality of items of drawing event information in the drawing event DB 150 to the client terminals connecting to the drawing server 100 through the transceiving unit 110.

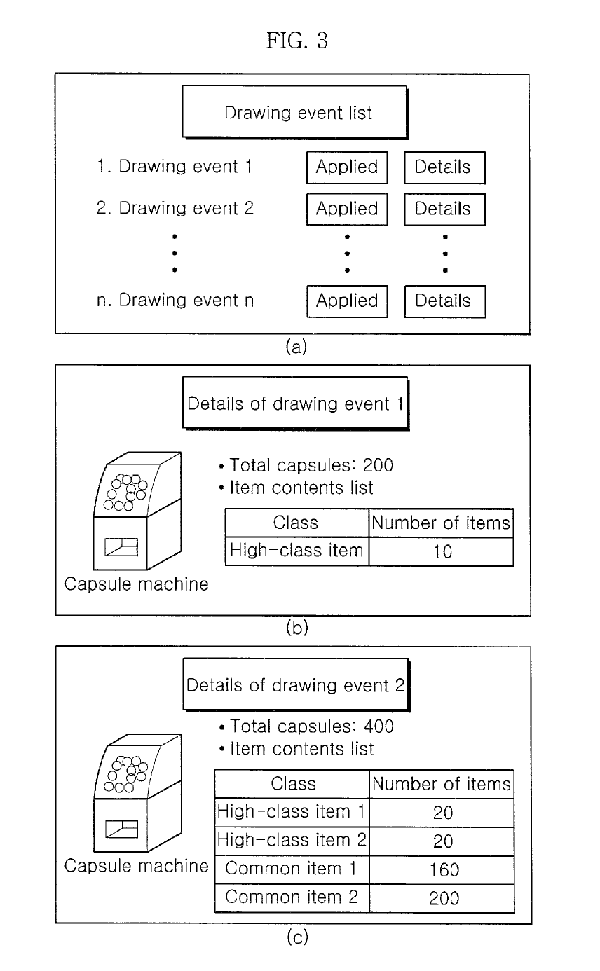

For example, as illustrated in (a) of FIG. 3, the drawing event providing unit 120 can provide a list of a plurality of drawing events according to a plurality of drawing event information, and as illustrated in (b) of FIG. 3, it can provide the details of the drawing events selected on the basis of input by the users on the client terminals 20 and the details of the item contents in the selected drawing events.

The details of the drawing events may provide the number of total capsules in the drawing event information and the number of capsules matched with item contents (the number of item contents in specific drawing events) and the details of the item contents may include the attribute information of the item contents applied to online games and predetermined values in the attribute information.

Further, as illustrated in (c) of FIG. 3, when a plurality of item contents is included in the drawing event information, the drawing event providing unit 120 can further provide the number of capsules matched with the item contents as the details of the drawing event and further provide the attribute information and ability values of the item contents as the details of the item contents.

Accordingly, the client terminals 20 can participate in a drawing event by selecting any one of the drawing events on the list and connecting to the drawing event corresponding to the drawing event information and the users of the client terminals 20 can acquire desired item contents by participating in the drawing events including the desired item contents.

The drawing event providing unit 120 matches the drawing event information corresponding to the drawing events selected by the client terminals 20 with the corresponding client terminals 20 and transmits it to the drawing unit 140 and the drawing unit 140 can provide winning information to the client terminals 20 corresponding to the drawing event information through the transceiving unit 110 by drawing on the basis of the drawing event information.

The drawing event providing unit 120 may allow a plurality of client terminals 20 to participate in drawing events according to the same drawing event information or limit the client terminals 20 such that only one client terminal 20 participate in one drawing event.

For one or more client terminals 20 participating in a drawing event according to the drawing event information, the drawing unit 140 can determine whether the client terminals win the item contents by drawing capsules in the drawing event information and provide the won item contents as the winning information to the client terminal 20.

The ‘drawing’ may mean a process of extracting a capsule selected in accordance with input information transmitted from the client terminals 20 by means of the drawing unit 140 or extracting a randomly and automatically selected capsule, and simultaneous extraction of a plurality of capsules may also be included in the drawing. Further, it includes various types of drawings known in the art and is not limited thereto.

The drawing unit 140 enables the user of the client terminal 20 to use the won item contents in online games, by registering the item contents provided as winning information on the membership information corresponding to the user of the client terminal 20 in the membership information stored in the member DB 310 of the member server 300.

Further, when drawing event information is allocated to any one client terminal 20 through the drawing event providing unit 120, the drawing unit 140 may restrict other client terminals to participate in the drawing event according to the allocated drawing event information by updating the drawing event DB 150.

Further, when all the item contents in drawing event information are won and supplied or the drawing event on the basis of the drawing event information is finished by the client terminal 20, the drawing unit 140 can update the list stored in drawing event DB 150 by resetting the corresponding drawing event information.

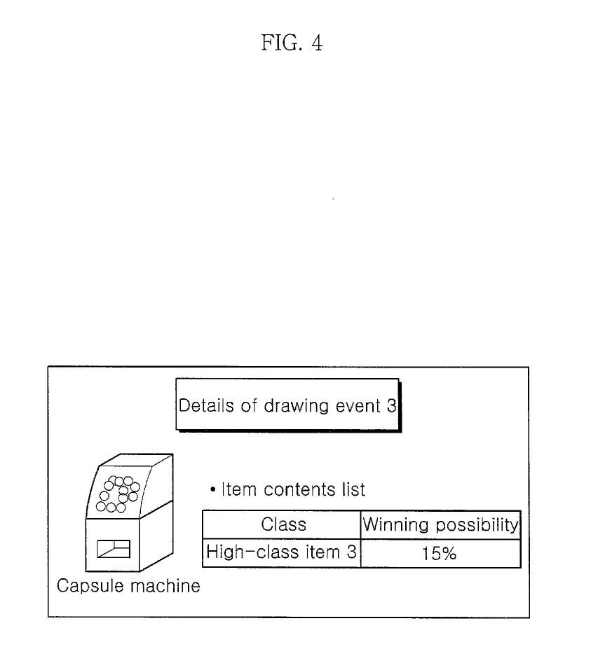

On the other hand, in the configuration described above, the capsule matching unit 130 may create drawing event information having winning probability determined for each of item contents by extracting one or more item contents from the contents DB 210 of the game contents server 20 under the control of the drawing event providing unit 120, and as illustrated in FIG. 4, by determining the winning probability for each of the item contents.

For example, the capsule matching unit 130 may create drawing event information that is composed of infinite capsules and which a predetermined probability for each of the item contents is applied to each of drawn capsules.

The capsule matching unit 130 can limit the number of item contents that are won to a predetermined number in the drawing event information.

Further, the capsule matching unit 130 may make the item contents be directly drawn without configuring the drawing event information with capsules, and accordingly, the item contents can be drawn in accordance with the winning probability of the item contents. In this configuration, when the item contents are drawn, it can be considered that the item contents are won.

Further, the matching unit 130 can set different winning probabilities for different types of item contents and the winning probabilities can be applied to each of the drawn capsules.

For example, the capsule matching unit 130 can set low winning probabilities for the high-class item contents and high winning probability for the common item contents in drawing event information including the high-class item contents and the common item contents. Further, a reference value may be preset for the winning probabilities and the capsule matching unit 130 may set the winning probabilities under the reference value for the high-class item contents and set the winning probabilities over the reference value for the common item contents.

Accordingly, the drawing event providing unit 120 can provide the drawing event according to drawing event information created by the capsule matching unit 130 to the client terminals 20. Further, as described above, when it is the drawing event information 120 with predetermined winning probabilities for item contents, the drawing event providing unit 120 can set the number of total capsules to the infinite and provide the details of a drawing event, and can provide the winning probabilities instead of the number of the item contents in the drawing event providing unit 120 as the details of the drawing event.

Accordingly, based on the drawing event information, when it is drawing event information with predetermined winning probabilities for item contents, the drawing unit 140 can determine whether the item contents are won, by applying the winning probabilities of the item contents to the capsules that are drawn by the client terminals participating in the drawing event.

As described above, when different types of item contents are included in drawing event information, the drawing unit 140 can determine item contents to be won by applying the winning probabilities of the item contents to the drawn capsules. When the item contents are directly drawn, the drawing unit 140 can determine whether the item contents are won in accordance with whether the item contents are drawn according to the probabilities of the item contents and can store the won item contents in the membership information corresponding to the users of the client terminals 20 in the membership information in the member DB 310 of the member server 300, as described above, and supply the won item contents so that the won item contents can be used in online games.

On the other hand, according to the configuration described above, the drawing unit 140 can provide winning insurance that provides item contents that users want, when the item contents are not won till a predetermined number of drawing times in spite of continuous drawings for the client terminals 20 participating in a drawing event.

To this end, the drawing unit 140 can include the drawing control unit 141 and the winning insurance unit 142, as illustrated in FIG. 2.

The drawing control unit 141, as described above, can determine whether the item contents for a capsule drawn in a drawing event according to drawing event information by a client terminal 20 participating in the drawing event are won.

The winning insurance unit 142 can provide winning insurance by registering item contents in the membership information of the user of the client 20 in combination with the drawing control unit 141, when the item contents included in the drawing event information are not won till a predetermined number of drawing times.

The winning insurance unit 142 can count (calculate) the number of drawing times in combination with the drawing control unit 141, and can provide an insurance function that immediately supplies item contents, which are provided by drawing in the drawing event, to a user, when the counted number of drawing times reaches a predetermined number of drawing times.

The winning insurance unit 142 can be set to count the number of drawing times on the basis of the accumulated number of capsules extracted by a drawing and may be set to count it on the basis of the accumulated number of times of the process of extracting capsules. For example, when two capsules are simultaneously extracted at one time, the winning insurance unit 142 may count the number of drawing times to two times in accordance with the number of the extracted capsules or may count it to one time regardless of the number of the extracted capsules.

Further, the winning insurance unit 142 may count the drawing input of the client terminal as the number of drawing times, when the item contents are directly drawn instead of capsules.

Accordingly, the winning insurance unit 142 can be inactivated and finish the insurance function, when the item contents are won within a predetermined number of drawing times, in combination with the drawing control unit 141.

On the other hand, the drawing server 100 according to an embodiment of the present invention may further include a winning insurance selling unit 160 and the winning insurance selling unit 160 can provide winning insurance contents for activating the winning insurance unit 142 to the client terminal 20. That is, the winning insurance unit 142 may provide the insurance function as described above, be being selectively activated in accordance with reception of the winning insurance contents.

The client terminal 20 can acquire the winning insurance contents, for example, in the way of purchasing the winning insurance contents with predetermined game money through the winning insurance selling unit 160 and the winning insurance selling unit 160 can register the purchased winning insurance contents on the membership information 310 in the member DB 300 which corresponds to the user of the client terminal 20.

Accordingly, the winning insurance unit 140 can be activated, depending on whether the client terminal 20 uses the winning insurance contents.

That is, the winning insurance unit 142 can be activated from the initial inactivated state, when the client terminal 20 uses the winning insurance contents, count the number of drawing times from the point of time of the activation, and supplies the item contents when the item contents are not won till a predetermined number of drawing times.

Further, when the item contents are won within a predetermined number of drawing times or the item contents are directly supplied (the item contents are registered on the membership information), the winning insurance unit 142 can delete the winning insurance contents from the membership information of the user and be inactivated.

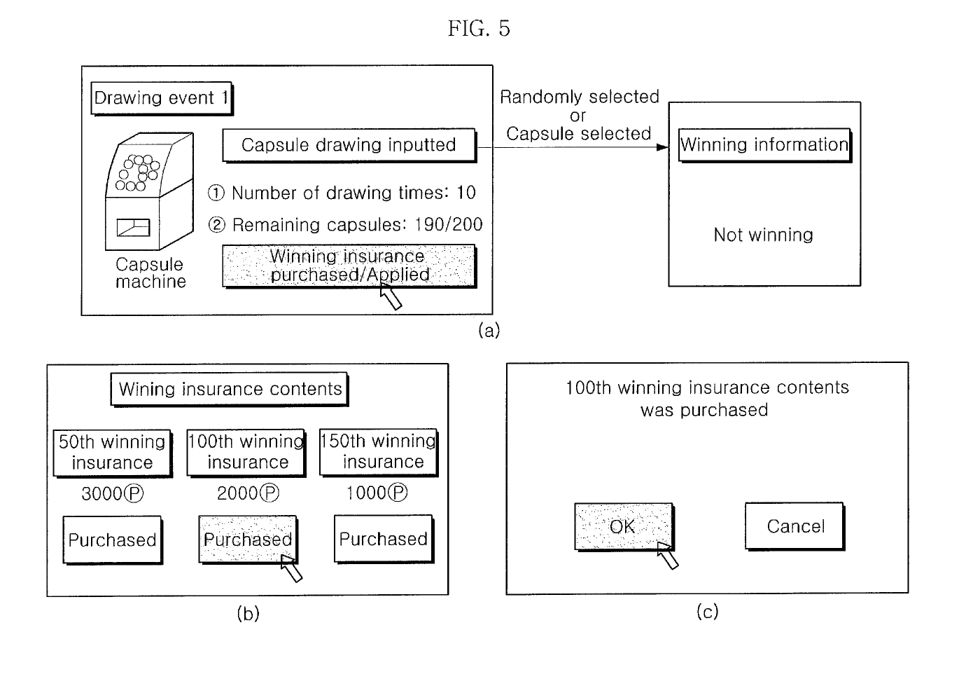

FIG. 5 is a diagram illustrating an example of the operation of the drawing control unit 141 and the winning insurance selling unit 160 on the basis of the configuration described above.

First, the drawing control unit 141, as illustrated in (a) of FIG. 5, can provide the item contents included in drawing event information corresponding to the drawing event according to any one of a plurality of items of drawing event information, by drawing client terminals participating in the drawing event.

The drawing control unit 141, as illustrated in the figure, can draw by extracting a capsule included in drawing event information in accordance with the input information or random selection of the client terminals 20 and can provide winning information for whether item contents are won, in accordance with whether the drawn capsule is matched with the item contents or in accordance with the winning probability of the item contents which is predetermined in advance in the drawing event information.

Further, the drawing control unit 141 can provide the client terminal 20 in real time with the information about at least one of ‘the number of drawing times’ for the number of capsules extracted from the drawing event information by drawing, ‘the number of total capsules’ included in the drawing event information, and ‘the number of remaining capsules’ except for the drawn capsules.

When the winning probability of item contents is predetermined drawing event information, the drawing control unit 141 may not provide the information on the ‘total number of capsules’ and ‘the number of remaining capsules’.

When outputting the drawing event according to the drawing event information to the client terminal 20, the drawing control unit 141 can link the connection address for purchasing the winning insurance contents provided by the winning insurance selling unit 160.

Accordingly, as illustrated in (b) of FIG. 5, the winning insurance selling unit 160 can provide different winning insurance contents to client terminals 20 connecting through the connection address. Further, the winning insurance selling unit 160 can provide the winning insurance contents in response to predetermined game money provided by the client terminals 20 or settlement using a settlement system.

The winning insurance selling unit 160 can provide different winning insurance contents with predetermined different types of drawing times and the winning insurance unit 142 can change the predetermined numbers of drawing times in accordance with the types of the winning insurance contents. This will be described in detail below.

The winning insurance selling unit 160 can register the winning insurance contents purchased by a client terminal 20 in the membership information corresponding to the user of the client terminal 20.

Accordingly, the drawing control unit 141 searches the membership information of the user of the client terminal participating in the drawing event according to the drawing even information from the member DB 310 of the member server 300, and when the winning insurance contents have been registered on the membership information, as illustrated in (c) of FIG. 5, the drawing control unit 141 can receive user input according to whether the winning insurance contents are transmitted from the client terminal 20 and can activate the winning insurance unit 142 in accordance with use of the winning insurance contents.

Although the winning insurance unit 142 is activated by winning insurance contents in the embodiment described above, the winning insurance selling unit 160 may not be provided.

In this case, the drawing control unit 141 can activate the winning insurance unit 142 every time it receives different items of drawing event information, and accordingly, the insurance function of the winning insurance unit 142 can be provided in each drawing event according to drawing event information.

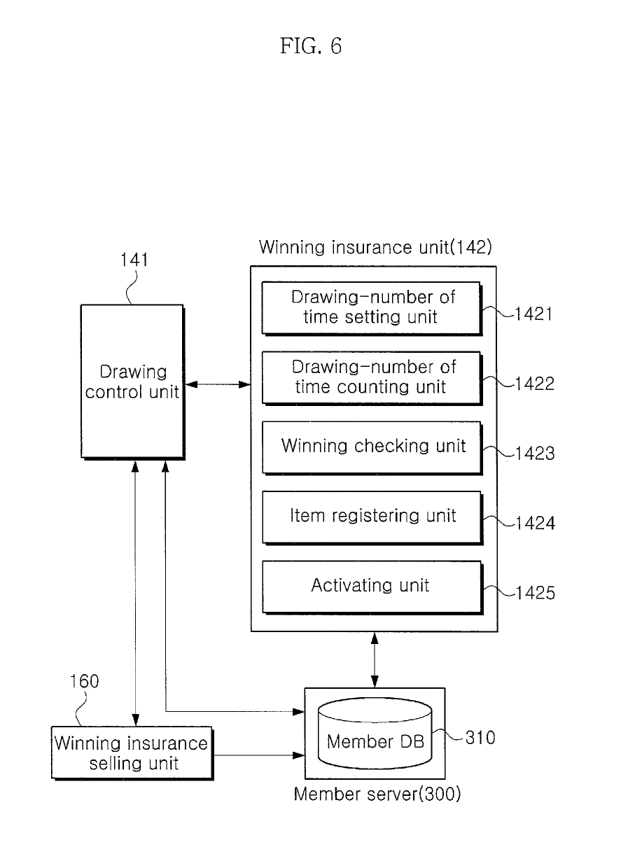

The winning insurance unit 142 can provide the winning insurance function in combination with the drawing control unit 141, which is described in detail with reference to the detailed configuration of the winning insurance unit 142 illustrated in FIG. 6 through FIGS. 7 to 10.

The winning insurance unit 142, as illustrated in FIG. 6, may include a drawing-number of time setting unit 1421, a drawing-number of time counting unit 1422, a winning checking unit 1423, an item registering unit 1424, and an activating unit 1425.

First, the activating unit 1425 can activate the winning insurance unit 142 by receiving winning insurance contents from the drawing control unit 141 in accordance with use of the winning insurance contents or receiving a control signal from the drawing control unit 141 receiving drawing event information.

The drawing-number of time setting unit 1421 can preset the number of drawing times for supplying item contents.

Further, the drawing-number of time setting unit 1421 can change the predetermined number of drawing times in accordance with the type of the winning insurance contents from the drawing control unit 141. For example, the drawing-number of time setting unit 1421 can change the number of drawing times, for example, fifty times or one hundred times in accordance with the type of the winning insurance contents.

Accordingly, the drawing-number of time counting unit 1422 counts the number of drawing times by the drawing control unit 141 in combination with the drawing control unit 141 and the winning checking unit 1423 can compare the number of drawing times counted by the drawing-number of time counting unit 1422 with the predetermined number of drawing times set by the drawing-number of time setting unit 1421.

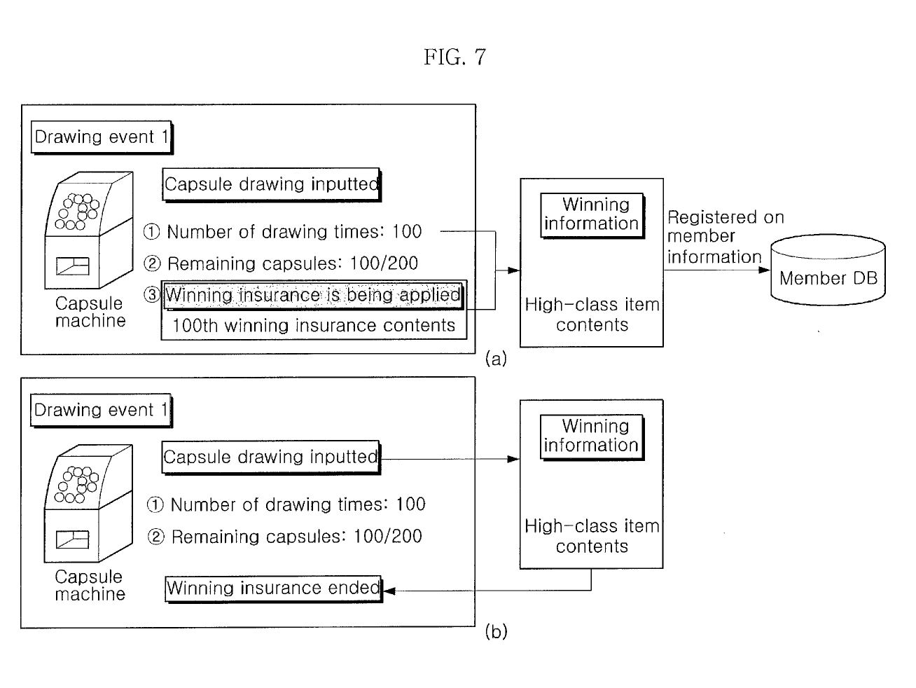

For example, as illustrated in (a) of FIG. 7, the winning checking unit 1423 can check whether the item contents are not won until the counted number of drawing times reaches the predetermined number of drawing times, by comparing the counted number of drawing times (\textcircled{1}) with the predetermined number of drawing times (\textcircled{3}) in real time.

When the item contents are not won till the predetermined number of drawing times, the winning checking unit 1423 provides a non-winning signal to the item registering unit 1424 and the item registering unit 1424 registers one of the item contents in the drawing event information on the membership information (membership information in the member DB 310 of the member server 300) which corresponds to the user of the client terminal so that the item contents can be used in online games, in combination with the drawing control unit 141 on the basis of the non-winning signal.

The item registering unit 1424 provides the winning information about the won item contents to the client terminal 20 in accordance with the insurance function, when registering the item contents in the membership information, so the user can know the item contents were won in accordance with the insurance function.

On the other hand, when the winning checking unit 1423 checks whether the item contents are won within the predetermined number of drawing times set by the drawing-number of time setting unit 1421 in combination with the drawing control unit 141 and the item contents were won, as illustrated in (b) of FIG. 7, it provides a winning signal to the activating unit 1425 and then the activating unit 1425 can finish the insurance function by inactivating the winning insurance unit 142 in response to the winning signal.

According to the configuration of the present invention, it is possible to enable a user to keep participating in a drawing at ease even if the user is not won even at a large number of drawing times, by providing winning insurance which provides the user with desired item contents through the insurance function of thee winning insurance unit 142, even if the user enters the drawing and the item contents are not won till a predetermined number of drawing times, and the conditions for acquiring item contents are gradually achieved with an increase in number of drawing times. Accordingly, it is possible to induce a user to actively enter a drawing and prevent thoughtless expenditure of a user in a drawing.

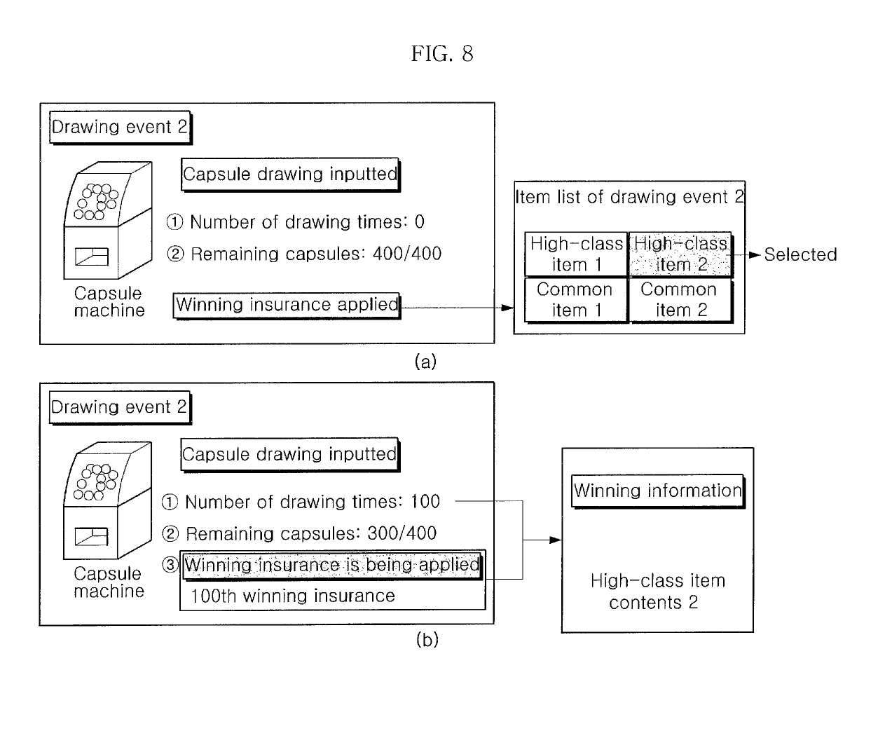

FIG. 8 is a diagram illustrating the configurations of different examples of the insurance function of the winning insurance unit 142 according to the function described above. As illustrated in the figure, when a plurality of item contents is included in drawing event information of a drawing event in which client terminals 20 participate and the item contents are different, the winning insurance unit 142, as illustrated in (a) of FIG. 8, can provide the client terminals 20 with an interface for receiving at least one selected from the item contents in the drawing event information, in combination with the drawing control unit 141.

Accordingly, the winning insurance unit 142 can select item contents that the user wants, by receiving selection information of the client terminals 20 through the interface.

Thereafter, the winning insurance unit 142, as illustrated in (b) of FIG. 8, determines whether high-class item contents 2, which are item contents selected in accordance with the selection information, are not won till a predetermined number of drawing times, and when the item contents are not won, it can register the high-class item contents 2 in the membership information of the user.

In (a) of FIG. 8, the winning insurance unit 142 supplies the non-won high-class item contents 2 till the predetermined number of drawing times without finishing the insurance function even if high-class item contents 1, which are non-selected item contents, are won, so it may be possible to acquire all of high-glass item contents with high ability values, which are measured in an online game, in one drawing event by the insurance function and the drawing function, and accordingly, it is possible to induce a user to actively enter a drawing.

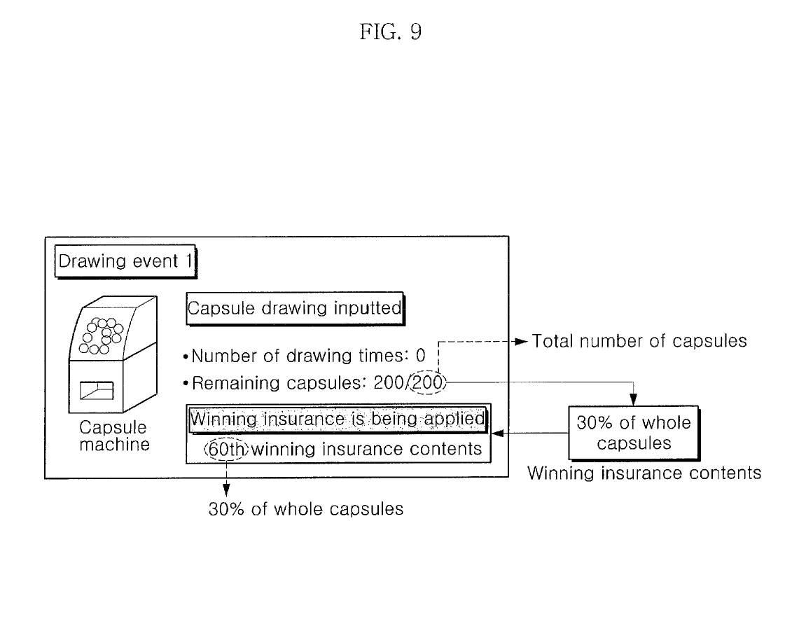

FIG. 9 is a diagram illustrating an another example of the winning insurance unit 142 for making the predetermined number of drawing times different for each drawing event, in which a ratio for changing the number of drawing times set in the winning insurance unit 142 in accordance with the number of capsules in drawing event information may be set in the winning insurance contents.

Accordingly, the winning insurance unit 142 can change the predetermined number of drawing times by applying the ratio set in the winning insurance contents to the number of total capsules in the drawing event information in accordance with use of the winning insurance contents.

For example, as illustrated in the figure, when the number of drawing times is set to 30% of the number of total capsules in the winning insurance contents, the winning insurance unit 142 can change the predetermined number of drawing times to sixty times by applying the ratio of 30% set in the winning insurance contents to 200 that is the number of total capsules in the drawing event information.

Accordingly, when item contents are not won till sixty times that is the predetermined number of drawing times, the winning insurance unit 142 can provide the item contents by registering it in the membership information of the user.

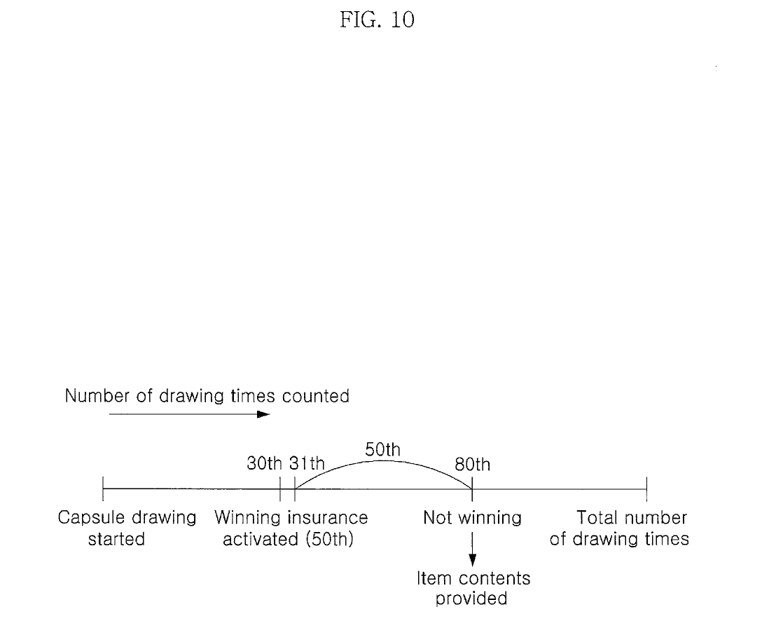

FIG. 10 is a diagram illustrating another example a reference of counting the number of winning times according to supply of item contents by the winning insurance unit 142 according to an embodiment of the present invention. As illustrated in the figure, the winning insurance unit 142 may start to be activated in the middle of a drawing by the drawing control unit 141, and accordingly, it may be possible to supply the item contents, when the item contents are not won till the predetermined number of drawing times, by counting the number of drawing times by the drawing control unit 141 from the point of time of activation.

For example, when the number of total capsules in the drawing event information is 200, all the capsule can be drawn through two hundred times of drawing. When the winning probability of the item contents is predetermined drawing event information, the number of total capsules may not be in connection.

Accordingly, when the winning insurance unit 142 is activated at the point of time in which the drawing control unit 141 has performed thirty times of drawing, the number of drawing times till thirty times of drawing is not counted and the number of drawing times may start to be counted as one time from the thirty one times of drawing.

Accordingly, when the predetermined number of drawing times is fifty times, the winning insurance unit 142 can supply item contents by registering it in the membership information of the user in accordance with the insurance function, when the item contents are not won from the thirty first drawing to the eightieth drawing.

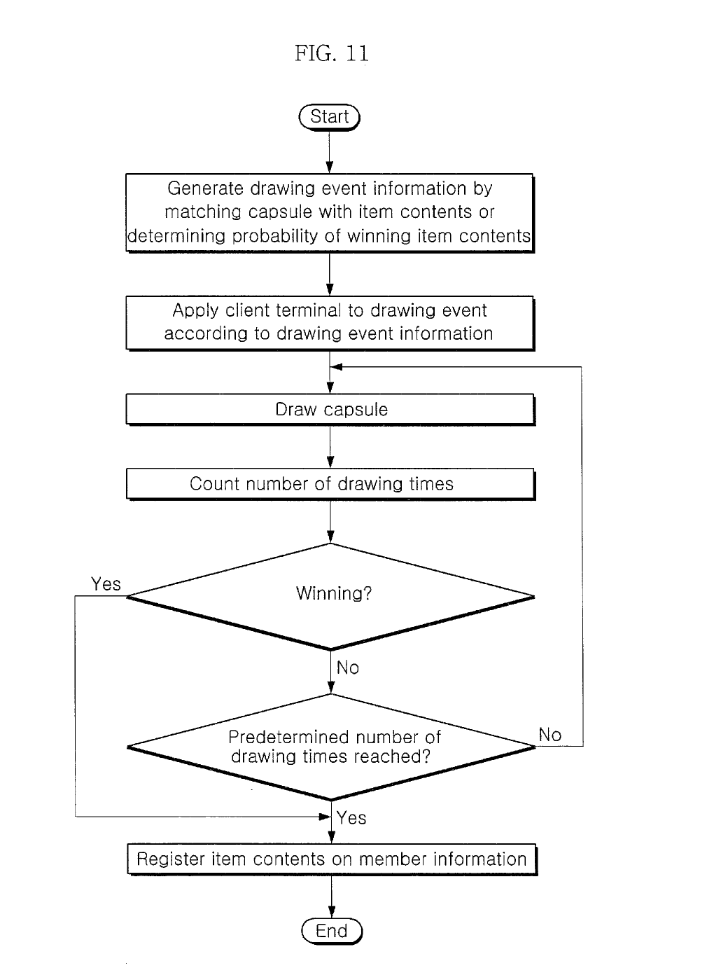

FIG. 11 is a flowchart illustrating an online drawing method of a drawing server according to an embodiment of the present invention. As illustrated in the figure, the capsule matching unit 130 can create drawing event information by matching one or more item contents with at least one or more capsules of a predetermined number of capsules or by determining the winning probability of item contents, under the control of the drawing event providing unit 120.

Next, the drawing event providing unit 120 can provide client terminals 20 with the drawing event according to the drawing event information created by the capsule matching unit 130.

Thereafter, when the client terminals 20 participate in the drawing event according to the drawing event information provided by the drawing event providing unit 120, the drawing event providing unit 120 matches the drawing event information with the client terminals and transmits related information to the drawing unit 140.

Accordingly, the drawing unit 140 can determine whether the item contents were won for each of capsules drawn in the drawing event by the client terminals 20 participating in the drawing event according to the drawing event information.

When the item contents are not won till the predetermined number of drawing times, the drawing unit 140 can register the item contents in the membership information of the users of the client terminals 20 by providing the winning insurance function.

What is claimed is:

1. An online drawing system that provides item contents that are used in an online game in online by drawing the item contents in combination with a game contents server that provides the item contents, the system comprising:
a capsule matching unit that creates drawing event information by matching one or more of the item contents with at least one of a predetermined number of capsules, respectively, or by determining a winning probability of the item contents;
a drawing event providing unit that provides the drawing event according to the created drawing event information to client terminals by controlling the capsule matching unit;
a drawing control unit that determines whether the item contents are won by a capsule drawn in the drawing event by the client terminal participating in the drawing event; and
a winning insurance unit that registers the item contents in the membership information of the user of the client terminal, when the item contents are not won till a predetermined number of drawing times, in combination with the drawing control unit.

2. The online drawing system of claim 1, further comprising a winning insurance providing unit that provides the client terminal with winning insurance contents for activating the winning insurance unit, and
the winning insurance unit activates the winning insurance, when receiving the winning insurance contents from the client terminal.

3. The online drawing system of claim 2, further comprising a winning insurance selling unit that provides different winning insurance contents,
wherein the winning insurance unit changes the predetermined number of drawing times in accordance with the types of the winning insurance contents.

4. The online drawing system of claim 2, wherein the winning insurance unit registers item contents in the membership information, when the item contents are not won till the predetermined number of drawing times from the point of time in activating, by counting the number of drawing times by the drawing control unit.

5. The online drawing system of claim 1, wherein the winning insurance unit changes the predetermined number of drawing times in accordance with the number of capsules in the drawing event information in combination with the drawing control unit.

6. The online drawing system of claim 1, wherein the winning insurance unit is inactivated, when the item contents is registered in membership information or the item contents or drawn within the predetermined number of drawing times.

7. The online drawing system of claim 1, wherein the drawing control unit resets the drawing event information, when the item contents in the drawing event information are all won.

8. The online drawing system of claim 1, wherein the item contents in the drawing event information are different types of item contents.

9. The online drawing system of claim 8, wherein the winning insurance unit provides an interface for receiving one or more selected from the item contents in the drawing event information through selection information of the client terminal, and registers the item contents selected through the interface in membership information, when the item contents selected through the interface are not won till the predetermined number of drawing times.

10. The online drawing system of claim 1, wherein the drawing control unit registers won item contents in the membership information of the user of the client terminal.

11. An online drawing method that provides item contents that are used in an online game in online by drawing the item contents in combination with a game contents server that provides the item contents, the system comprising:
a first step that creates drawing event information by matching one or more of the item contents with at least one of a predetermined number of capsules, respectively, or by determining a winning probability of the item contents;
a second step that provides the drawing event according to the created drawing event information to a client terminals through the first step;
a third step that determines whether the item contents are won by a capsule drawn in the drawing event by the client terminal participating in the drawing event; and
a fourth step that registers the item contents in the membership information of the user of the client terminal, when the item contents are not won till a predetermined number of drawing times in the third step.

12. The online drawing method of claim 11, wherein the second step includes a step of providing the client terminal with winning insurance contents for performing the fourth step, and
the fourth step is performed, when receiving the winning insurance contents as input information of the client terminal.

13. The online drawing method of claim 12, wherein the second step provides a plurality of different winning insurance contents, and
the fourth step changes the predetermined number of drawing times in accordance with the types of received winning insurance contents.

14. The online drawing method of claim 12, wherein the fourth step registers item contents in the membership information, when the item contents are not won till the predetermined number of drawing times, by counting the number of drawing times from the point of time when the winning insurance contents are received.

15. The online drawing method of claim 11, wherein the fourth step changes the predetermined number of drawing times in accordance with the number of capsules in the drawing event information.

16. The online drawing method of claim 11, further comprising a fifth step that finishes the fourth step, when the item contents are won within the predetermined number of drawing times.

17. The online drawing method of claim 11, further comprising a sixth step that resets the drawing event information, when the item contents in the drawing event information are all won.

18. The online drawing method of claim 11, wherein the item contents in the drawing event information are different types of item contents.

19. The online drawing method of claim 18, wherein the fourth step provides an interface for receiving one or more selected from the item contents in the drawing event information through selection information of the client terminal, and registers the item contents selected through the interface in membership information, when the item contents selected through the interface are not won till the predetermined number of drawing times.

20. The online drawing method of claim 11, wherein the third step registered won item contents in the membership information of the user of the client terminal.
